(19) United States
(12) Patent Application Publication
(10) Pub. No.: US 2012/0290507 A1
(43) Pub. Date: Nov. 15, 2012

(54) CARPOOL FARE ORGANIZER AND METHOD FOR GENERATING CARPOOL FARES

(75) Inventors: Hung-Min Sun, Hsinchu (TW); Bying-He Ku, Hsinchu (TW); Chi-ming Li, Hsinchu (TW); Chia Yun Cheng, Hsinchu (TW)

(73) Assignee: National Tsing Hua University, Hsinchu (TW)

(21) Appl. No.: 13/205,919

(22) Filed: Aug. 9, 2011

(30) Foreign Application Priority Data
May 11, 2011 (TW) 100116459

(51) Int. Cl. G07B 13/04

(52) U.S. Cl. 705/417

(57) ABSTRACT

A carpool fare organizer is useful when there is at least one passenger and comprises a distance recording unit, a passenger calculating unit, a fare calculating module and at least one display device. The distance recording unit records a get-in distance, a get-out distance and an accumulated distance of each passenger. The passenger calculating unit calculates a number of passengers. The fare calculating module calculates an original fare, an accumulated discount and an economical fare. A method for generating carpool fares comprises steps of recording a get-in distance, a get-out distance and an accumulated distance of each passenger and a number of passengers, and calculating an economical fare with the get-in distance, the get-out distance, the accumulated distance and the number of passengers.

### FIELD OF THE INVENTION

The present invention is a carpool fare organizer and a method for generating carpool fares.

### BACKGROUND OF THE INVENTION

Carpooling is commuting in groups, so that several passengers can travel to their desired destinations in a single vehicle. Carpooling reduces individual commuting costs by sharing travel expenses, such as fuel, tolls, and car rental between the people in the given carpool. It is also a more environmentally friendly and sustainable way to travel because carpooling reduces carbon emissions, traffic and parking spaces. Carpools are arranged by car control centers which dispatch cars to passengers.

U.S. Patent No. 20100161392 discloses a method including service methods, articles of manufacture, systems, articles and programmable devices for charging travel fees or awarding benefits as a function of vehicle occupancy.

However, the previous method only provides benefits for the passengers. There is no gain for the car control center.

Accordingly, a new carpool fare organizer and method for generating carpool fares is needed to overcome the current problems.

### SUMMARY OF THE INVENTION

The primary objective of the present invention is to apply carpool benefits to the car control center.

The carpool fare organizer in accordance with the present invention comprises a distance recording unit, a passenger calculating unit, a fare calculating module and at least one display device.

The distance recording unit records a get-in distance, a get-out distance and an accumulated distance for each passenger. The passenger calculating unit calculates the number of passengers in the carpool. The fare calculating module calculates an original fare, an accumulated discount and an economical fare of each passenger. The display device displays the accumulated distance, the original fare, the accumulated discount and the economical fare.

The method of generating carpool fares in accordance with the present invention comprises steps of recording a get-in distance, a get-out distance, an accumulated distance of each passenger and the number of passengers, and calculating an economical fare with the get-in distance, the get-out distance, the accumulated distance and the number of passengers.

### BRIEF DESCRIPTION OF THE DRAWINGS

FIG. 1 is a functional block diagram of a first embodiment of a carpool fare organizer in accordance with the present invention;

FIG. 2 is a functional block diagram of a second embodiment of a carpool fare organizer in accordance with the present invention;

FIG. 3 is a flowchart of a first embodiment of a method for generating carpool fares in accordance with the present invention; and

FIG. 4 is a flowchart of a second embodiment of a method for generating carpool fares in accordance with the present invention.

### DETAILED DESCRIPTION OF THE PRESENT INVENTION

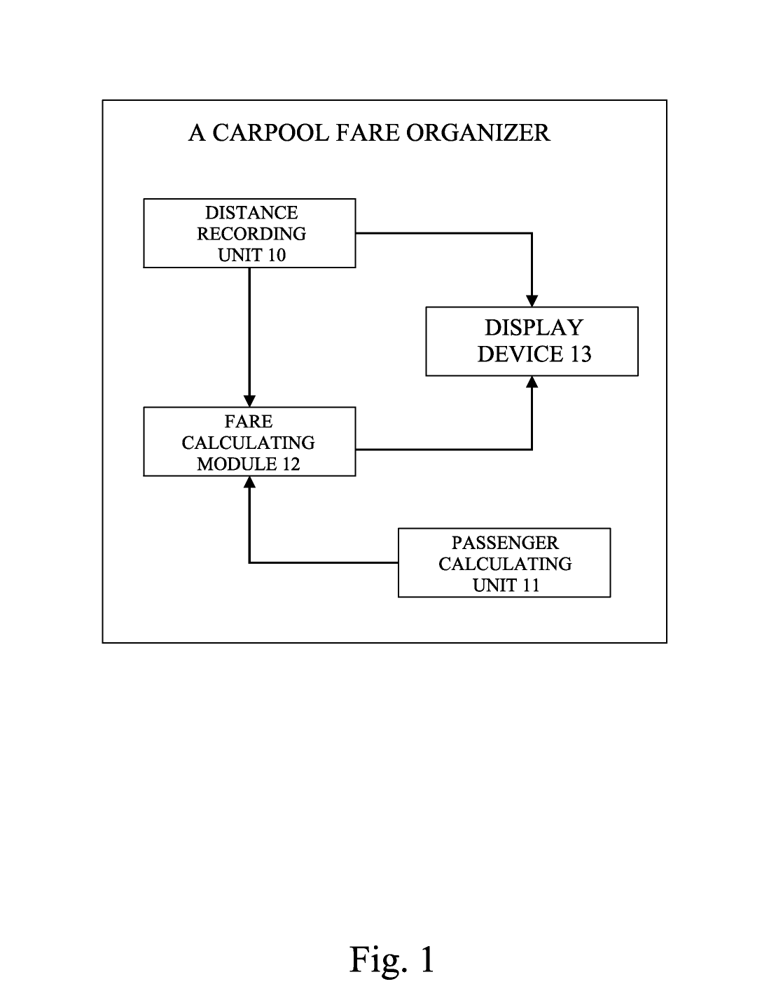

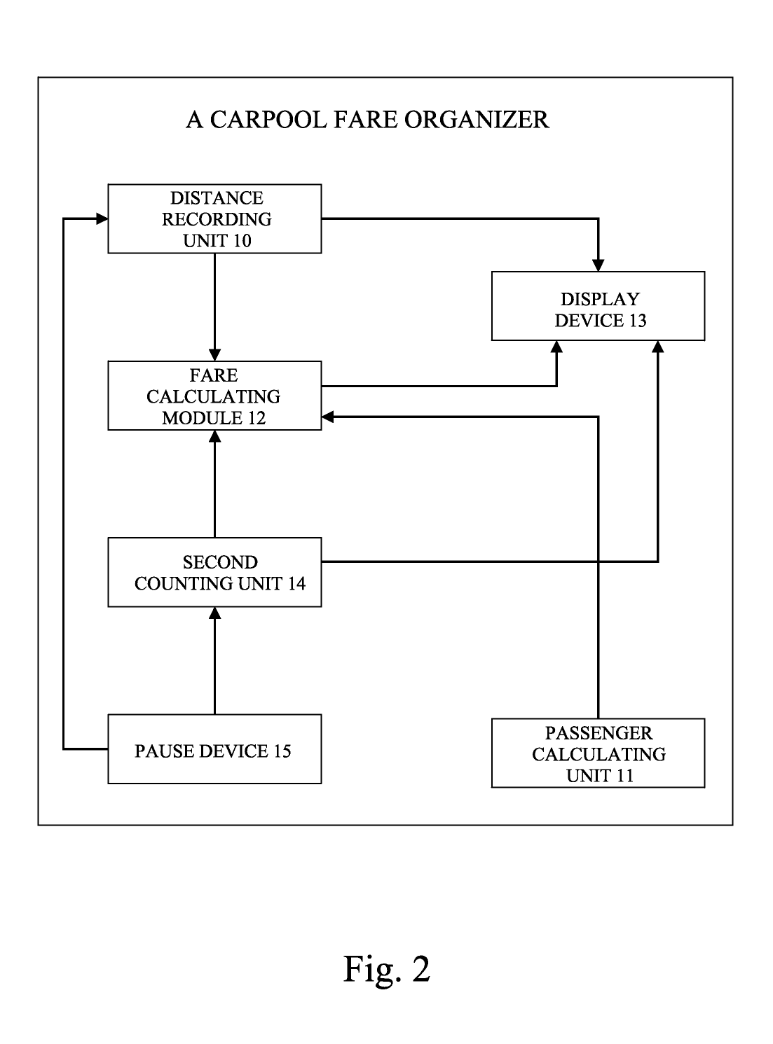

With reference to FIGS. 1 and 2, a carpool fare organizer (1) in accordance with the present invention is used with carpools having at least one passenger (N) in a car, comprises a distance recording unit (10), a passenger calculating unit (11), a fare calculating module (12), at least one display device (13), an optional second counting unit (14) and optionally at least one pause device (15). The car travels at a car speed and has a lag speed. The car speed is variable when the car is traveling. The lag speed is a fixed value for charging an additional fare when the car is in slower or stopped traffic. The carpool fare organizer (1) is used by a car control center.

The distance recording unit (10) records a get-in distance, a get-out distance and an accumulated distance for each passenger.

The passenger calculating unit (11) calculates the number of passengers

The fare calculating module (12) is connected to the distance recording unit (10) and the passenger calculating unit (11). The fare calculating module (12) calculates an original fare, an accumulated discount and an economical fare of each passenger with the get-in distance, the get-out distance, the accumulated distance and the number of passengers (N) in the car. The original fare is a fare without the accumulated discount. The accumulated discount is an amount saved by the carpool. The economical fare is a fare with the accumulated discount applied, which varies dynamically based on the number of passengers (N) in the car and the accumulated distance. The economical fare may further comprise a lag fare. The lag fare is f dollars per h seconds.

The display device (13) is connected to the distance recording unit (10) and the fare calculating module (12) and displays the accumulated distance, the original fare, the accumulated discount and the economical fare.

The optional second counting unit (14) is connected to the fare calculating module (12) and the display device (13) and counts a lag time when the car speed is less than the lag speed and may recount the lag time when the car speed is greater than the lag speed. The lag time may be displayed by the display device (13).

The optional pause device (15), which is connected to the distance recording unit (10) and the optional second counting unit (14), pauses the distance recording unit (10) and the optional second counting unit (14).

The economical fare comprises a first embodiment of an economical fare, a second embodiment of an economical fare and a third embodiment of an economical fare.

With further reference to Table 1, the first embodiment of the economical fare is calculated in the fare calculating module (12) that saves a start section, at least one passenger carpool section (P), at least one section length (Dᵢ), a basic fare (B), a section unit price (M), at least one carpool section economical discount (Sᵢ) and a start section economical discount (Z). The index i is an integer in a range of 1 to (P). The carpool section economical discount (Sᵢ) varies based on the number of the passengers (N). The accumulated discount is

$${\sum }_{i = 1}^{P} {D}_{i} \times M \times ( 1 - {S}_{i} ) ,$$

and the economical fare is B×Z+Σᵢ₌₁^{P}Dᵢ×M×Sᵢ dollars.

TABLE 1

| | km | | | | | | | |
|---|---|---|---|---|---|---|---|---|
| passenger | 0~1.25 | 1.25~2 | 2~3 | 3~3.25 | 3.25~4.25 | 4.25~6 | 6~6.2 | 6.2~7 |
| A | 1250 m | 750 m | 1000 m | | | 3000 m | 200 m | |
| | 0.056 * 1 | 0.02 * 1 | 0.02 * 0.6 | | | 0.02 * 0.5 | 0.02 * 0.6 | |
| B | | | 1000 m | 250 m | 2750 m | | | |
| | | | 0.056 * 0.6 | 0.056 * 0.5 | | 0.02 * 0.5 | | |
| C | | | | 1250 m | | 1750 m | 200 m | 800 m |
| | | | | 0.056 * 0.5 | | 0.02 * 0.5 | 0.02 * 0.6 | 0.02 * 1 |

In the example depicted in Table 1, the start section is 1250 m. The basic fare (B) is 70 Taiwan dollars. The section unit price (M) is 0.02 Taiwan dollars per meter. The carpool section economical discount (Sᵢ) is 100% when a passenger is in a passenger carpool section (P), is 60% when two passengers are in a passenger carpool section (P), is 50% when three passengers are in a passenger carpool section (P).

The original fare of passenger A is 70+(6200−1250)×0.02=169 Taiwan dollars. The accumulated discount of passenger A is 1250×0.056×(1−1)+(2000−1250)×0.02×(1−1)+(3000−2000)×0.02×(1−0.6)+(6000−3000)×0.02×(1−0.5)+(6200−6000)×0.02×(1−0.6)=39.6 Taiwan dollars. The economical fare of passenger A is 169−39.6=129.4 Taiwan dollars.

The original fare of passenger B is 70+(6000−2000−1250)×0.02=125 Taiwan dollars. The accumulated discount of passenger B is 1000×0.056×(1−0.6)+(1250−1000)×0.056×(1−0.5)+(6000−2000−1250)×0.02×(1−0.5)=56.9 Taiwan dollars. The economical fare of passenger B is 125−56.9=68.1 Taiwan dollars.

The original fare of passenger C is 70+(7000−3000−1250)×0.02=125 Taiwan dollars. The accumulated discount of passenger C is 1250×0.056×(1−0.5)+(6000−3000−1250)×0.02×(1−0.5)+(6200−6000)×0.02×(1−0.6)+(7000−6200)×0.02×(1−1)=54.1 Taiwan dollars. The economical fare of passenger C is 125−54.1=70.9 Taiwan dollars.

The original fare of the car control center is 70+(7000−1250)×0.02=185 Taiwan dollars. The economical fare of the car control center is 129.4+68.1+70.9=268.4 Taiwan dollars. The increased revenue of the car control center is 268.4−185=83.4 Taiwan dollars.

With further reference to Table 2, the second embodiment of an economical fare has a derivation benefit and is calculated in the fare calculating module (12) which further saves at least one present fare when a passenger travels alone in the car (Uᵢ), at least one passenger carpool section of non-first passenger (p), at least one section length of non-first passenger (dᵢ), a share interest rate of passenger (b) and at least one section unit price of a non-first passenger (Mᵢⱼ). The passenger calculating unit further saves a number of non-first passengers of each section (Cᵢ). An index i is an integer in a range of 1 to (p), and a variable j is an integer in a range of 1 to (N). The accumulated discount is

$$b \times {\sum }_{i = 1}^{p} [ {\sum }_{j = 1}^{{C}_{i}} ( {d}_{i} \times {M}_{ij} ) ] / ( {C}_{i} + 1 ) ,$$

and the economical fare is calculated as

$${U}_{i} - b \times {\sum }_{i = 1}^{p} [ {\sum }_{j = 1}^{{C}_{i}} ( {d}_{i} \times {M}_{ij} ) ] / ( {C}_{i} + 1 )$$

dollars.

TABLE 2

| | km | | | | | | | | | | | | | | | |
|---|---|---|---|---|---|---|---|---|---|---|---|---|---|---|---|---|
| passenger | 0~1.25 | | 1.25~2 | | 2~3 | | 3~3.25 | | 3.25~4.25 | | 4.25~5 | | 5~5.2 | | 5.2~6 | |
| A | 1250 | m | 750 | m | 1000 | m | 250 | m | 1000 | m | 750 | m | 200 | m | | |
| | 0.056 | | 0.02 | | 0.02 | | 0.02 | | 0.02 | | 0.02 | | 0.02 | | | |
| B | | | | | 1000 | m | 250 | m | 1000 | m | 750 | m | | | | |
| | | | | | 0.056 | | 0.056 | | 0.02 | | 0.02 | | | | | |
| C | | | | | | | 250 | m | 1000 | m | 750 | m | 200 | m | 800 | m |
| | | | | | | | 0.056 | | 0.056 | | 0.02 | | 0.02 | | 0.02 | |

In the example depicted in Table 2, the start section is 1250 m. The basic fare (B) is 70 Taiwan dollars. The start section unit price (M) is 0.056 Taiwan dollars per meter. The continuing section unit price (M) is 0.02 Taiwan dollars per meter. The carpool section economical discount (Sᵢ) is the section unit price (M) divided by the number of passengers. 30% of the derivation benefit is allocated to the car control center, and 70% of the derivation benefit is allocated to the passengers.

The original fare of passenger A is 70+(5200−1250)×0.02=149 Taiwan dollars. The accumulated discount of passenger A is 0.056×1000/2+(0.056+0.056)×250/3+(0.02+0.056)×1000/3+(0.02+0.02)×750/3+0.02×200/2=74.67 Taiwan dollars. The economical fare of passenger A is 149−74.67×0.7=96.731 Taiwan dollars.

The original fare of passenger B is 70+(5000−2000−1250)×0.02=105 Taiwan dollars. The accumulated discount of passenger B is 0.056×1000/2+(0.056+0.056)×250/3+(0.02+0.056)×1000/3+(0.02+0.02)×750/3=72.67 Taiwan dollars. The economical fare of passenger B is 105−72.67×0.7=54.131 Taiwan dollars.

The original fare of passenger C is 70+(6000−3000−1250)×0.02=105 Taiwan dollars. The accumulated discount of passenger C is (0.056+0.056)×250/3+(0.02+0.056)×1000/3+(0.02+0.02)×750/3+0.02×200/2=46.67 Taiwan dollars. The economical fare of passenger C is 105−46.67×0.7=72.33 Taiwan dollars.

The original fare of the car control center is 70+(6000−1250)×0.02=165 Taiwan dollars. The economical fare of the car control center is 96.731+54.131+72.33=223.192 Taiwan dollars. The increased revenue of the car control center is 268.4−185=83.4 Taiwan dollars.

TABLE 3

| | km | | | | | | | | | | | | | | | | | |
|---|---|---|---|---|---|---|---|---|---|---|---|---|---|---|---|---|---|---|
| passenger | 0~1.25 | | 1.25~2 | | 2~3 | | 3~3.25 | | 3.25~4.25 | | 4.25~5 | | 5~6 | | 6~6.5 | | 6.5~7 | |
| A | 1250 | m | 750 | m | 1000 | m | 250 | m | | | | | | | | | | |
| | 0.056 | | 0.02 | | 0.02 | | 0.02 | | | | | | | | | | | |
| B | | | | | 1000 | m | 250 | m | 1000 | m | 750 | m | 1000 | m | 500 | m | | |
| | | | | | 0.056 | | 0.056 | | 0.02 | | 0.02 | | 0.02 | | 0.02 | | | |
| C | | | | | | | 250 | m | 1000 | m | 750 | m | | | | | | |
| | | | | | | | 0.056 | | 0.056 | | 0.02 | | | | | | | |
| D | | | | | | | | | | | | | | | 500 | m | 500 | m |
| | | | | | | | | | | | | | | | 0.056 | | 0.056 | |

With further reference to Table 3, the third embodiment of the economical fare has a derivation benefit. 30% of the derivation benefit is allocated to the car control center, and 70% of the derivation benefit is allocated to the passengers.

The original fare of passenger A is 70+(3250−1250)×0.02=110 Taiwan dollars. The accumulated discount of passenger A is 0.056×1000/2+(0.056+0.056)×250/3=37.33 Taiwan dollars. The economical fare of passenger A is 110−37.33×0.7=83.87 Taiwan dollars.

The original fare of passenger B is 70+(6500−2000−1250)×0.02=135 Taiwan dollars. The accumulated discount of passenger B is 0.056×1000/2+(0.056+0.056)×250/3+(0.056)×1000/2+(0.02)×750/2+0.056×500/2=86.83 Taiwan dollars. The economical fare of passenger B is 135−86.83×0.7=74.219 Taiwan dollars.

The original fare of passenger C is 70+(5000−3000−1250)×0.02=85 Taiwan dollars. The accumulated discount of passenger C is (0.056+0.056)×250/3+(0.056)×1000/2+(0.02)×750/2=44.83 Taiwan dollars. The economical fare of passenger C is 85−44.83×0.7=53.619 Taiwan dollars.

The original fare of passenger D is 70+(7000−6000−1250)×0.02=65 Taiwan dollars. Because 65 Taiwan dollars is less than 70 Taiwan dollars, the original fare of passenger D is 70 Taiwan dollars (the basic fare B). The accumulated discount of passenger D is 0.056×500/2=14 Taiwan dollars. The economical fare of passenger D is 70−14×0.7=60.2 Taiwan dollars.

The original fare of the car control center is 70+(7000−1250)×0.02=185 Taiwan dollars. The economical fare of the car control center is 83.87+74.219+53.619+60.2=271.908 Taiwan dollars. The increased revenue of the car control center is 271.908−185=86.908 Taiwan dollars.

TABLE 4

| | km | | | | | | | | | | | |
|---|---|---|---|---|---|---|---|---|---|---|---|---|
| passenger | 0~2 | | 2~3 | | 3~4 | | 4~5 | | 5~5.2 | | 5.2~6 | |
| A | 2000 | m | 1000 | m | 1000 | m | 1000 | m | 200 | m | | |
| | 70 | s | 20 | s | 10 | s | 60 | s | 10 | s | | |
| B | | | 1000 | m | 1000 | m | 1000 | m | | | | |
| | | | 20 | s | 10 | s | 60 | s | | | | |
| C | | | | | 1000 | m | 1000 | m | 200 | m | 800 | m |
| | | | | | 10 | s | 60 | s | 10 | s | 30 | s |

With further reference to Table 4, the lag fare is decided by calculating a first embodiment of a lag fare and calculating a second embodiment of a lag fare.

Calculating the first embodiment of the lag fare is performed in the fare calculating module (12) which saves at least one lag time of passenger (Tᵢ), and the lag fare per h seconds of each passenger is f×Tᵢ/Σᵢ₌₁^{N}Tᵢ dollars.

For example, when the lag fare is 5 Taiwan dollars per 100 seconds and the lag speed is 5 km per hour.

The lag fare of passenger A is 5×100/(100+30+10)=3.57 Taiwan dollars.

The lag fare of passenger B is 5×30/(100+30+10)=1.07 Taiwan dollars.

The lag fare of passenger C is 5×10/(100+30+10)+5×100/(100)=5.36 Taiwan dollars.

Calculating the second embodiment of the lag fare is performed by the fare calculating module (12) which further saves at least one lag counting section of passenger (R) and at least one second lag counting section (Eᵢ). The passenger calculating unit further saves at least one passenger in the lag counting section (Vᵢ) where the index i is in a range of 1 to (R), and the lag fare of each passenger per h seconds is Σᵢ₌₁^{R}f×(Eᵢ/h)×(1/Vᵢ) dollars.

For example, the lag fare is 5 Taiwan dollars per 100 seconds, and the lag speed is 5 km per hour.

The lag fare of passenger A is 5×(70/100)×1+5×(20/100)×(1/2)+5×(10/100)×(1/3)+5×(60/100)×(1/3)+5×(10/100)×(1/2)=5.41 Taiwan dollars.

The lag fare of passenger B is 5×(20/100)×(1/2)+5×(10/100)×(1/3)+5×(60/100)×(1/3)=1.67 Taiwan dollars.

The lag fare of passenger C is 5×(10/100)×(1/3)+5×(60/100)×(1/3)+5×(10/100)×(1/2)+5×(30/100)×1=2.92 Taiwan dollars.

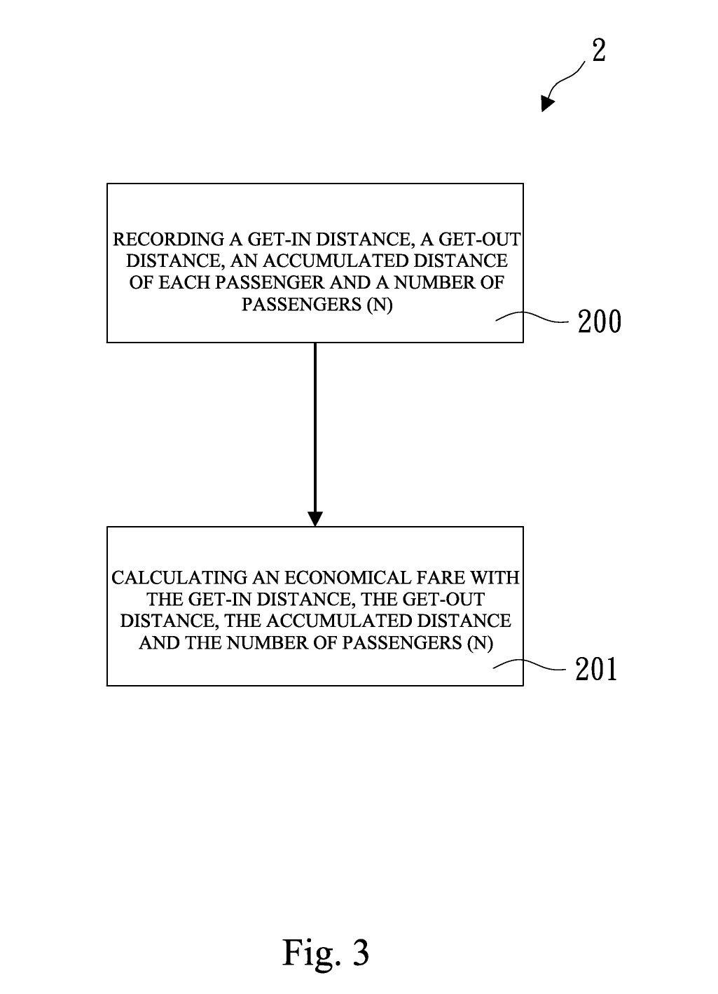

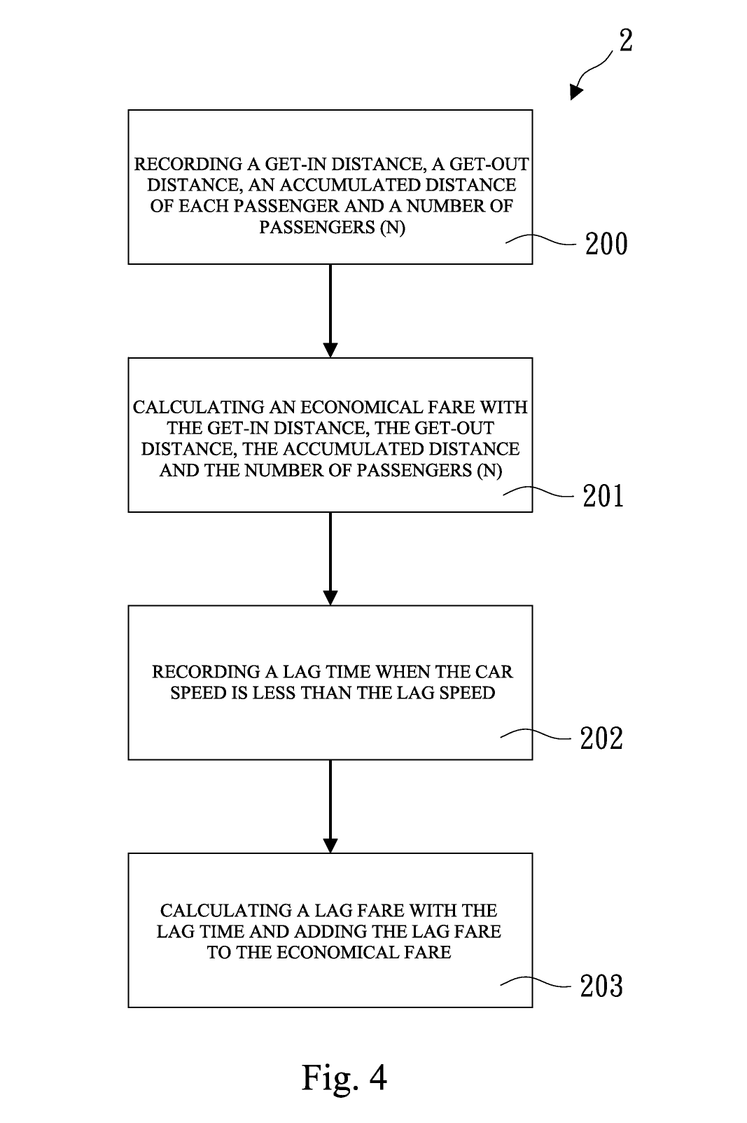

With reference to FIGS. 3 and 4, a method of generating carpool fares (2) in accordance with the present invention is utilized by at least one passenger (N) in a car using a carpool scheme, wherein the car travels at a car speed and has a lag speed. The car speed is variable when the car is traveling. The lag speed is a fixed value for charging an additional fare when the car is in slow traffic.

The method of generating carpool fares (2) comprises steps of step 200 recording a get-in distance, a get-out distance, an accumulated distance of each passenger and a number of passengers (N) and step 201 calculating an economical fare with the get-in distance, the get-out distance, the accumulated distance and the number of passengers (N) and may comprise steps of step 202 recording a lag time when the car speed is less than the lag speed and step 203 calculating a lag fare with the lag time and adding the lag fare to the economical fare.

The economical fare dynamically varies depending on the number of passengers (N) and the accumulated distance.

Various changes can be made to the method without departing from the broad spirit and scope of the invention.

What is claimed is:

1. A carpool fare organizer used by at least one passenger in a car using a carpool comprising
a distance recording unit recording a get-in distance, a get-out distance and an accumulated distance of each passenger;
a passenger calculating unit calculating a number of passengers;
a fare calculating module being connected to the distance recording unit and the passenger calculating unit and calculating an original fare, an accumulated discount and an economical fare of each passenger with the get-in distance, the get-out distance, the accumulated distance and the number of passengers, wherein the original fare is a fare without the accumulated discount, the accumulated discount is a fare saved by the carpool, the economical fare is a fare with the accumulated discount and varies dynamically based on the number of passengers and the accumulated distance; and
at least one display device being connected to the distance recording unit and the fare calculating module and displaying the accumulated distance, the original fare, the accumulated discount and the economical fare.

2. The carpool fare organizer as claimed in claim 1, wherein the fare calculating module further saves a start section, at least one passenger in a carpool section P, at least one section length Dᵢ, a basic fare B, a section unit price M, at least one carpool section economical discount Sᵢ and a start section economical discount Z, i is an index and is an integer in a range of 1 to P, the carpool section economical discount Sᵢ varies based on the number of passengers, the accumulated discount is
$${\sum }_{i = 1}^{P} {D}_{i} \times M \times ( 1 - {S}_{i} ) ,$$
and the economical fare is B×Z+Σᵢ₌₁^{P}Dᵢ×M×Sᵢ dollars.

3. The carpool fare organizer as claimed in claim 1, wherein the fare calculating module further saves at least one present fare when a passenger traveling alone in the car at least one passenger carpool section of non-first passenger p, at least one section length of non-first passenger dᵢ, a share interest rate of passenger b and at least one section unit price of non-first passenger Mᵢⱼ, the passenger calculating unit further saves a number of non-first passengers of each section Cᵢ, i is an index and an integer in a range of 1 to p, j is an index and an integer in a range of 1 to the number of passengers, the accumulated discount is
$$b \times {\sum }_{i = 1}^{p} [ {\sum }_{j = 1}^{{C}_{i}} ( {d}_{i} \times {M}_{ij} ) ] / ( {C}_{i} + 1 ) ,$$
the economical fare is
$${U}_{i} - b \times {\sum }_{i = 1}^{p} [ {\sum }_{j = 1}^{{C}_{i}} ( {d}_{i} \times {M}_{ij} ) ] / ( {C}_{i} + 1 )$$
dollars.

4. The carpool fare organizer as claimed in claim 1, wherein the car travels at a car speed and has a lag speed, the car speed is variable when the car is traveling, the lag speed is a fixed value for charging an additional fare when the car is in slow traffic, and the system for carpool fares further comprises
a second counting unit being connected to the fare calculating module and the display device and counting a lag time that the car speed less than the lag speed; and
at least one pause device being connected to the distance recording unit and the second counting unit and pausing the distance recording unit and the second counting unit.

5. The carpool fare apparatus as claimed in claim 4, wherein the display device further displays the lag time.

6. The carpool fare apparatus as claimed in claim 4, wherein the economical fare further comprises a lag fare, the lag fare is f dollars per h seconds, the second counting unit recounts the lag time when the car speed is greater than the lag speed, the fare calculating module further saves at least one lag time of passenger Tᵢ, the lag fare per h seconds of each passenger is f×Tᵢ/Σᵢ₌₁^{N}Tᵢ dollars.

7. The carpool fare apparatus as claimed in claim 4, wherein the economical fare further comprises a lag fare, the lag fare is f dollars per h seconds, the second counting unit recounts the lag time when the car speed is greater than the lag speed, the fare calculating module further saves at least one number of lag counting section of passenger R and at least one second of lag counting section Eᵢ, the passenger calculating unit further saves at least one passenger in lag counting section Vᵢ, i is an index in a range of 1 to R, and the lag fare of each passenger in h seconds is Σᵢ₌₁^{R}f×(Eᵢ/h)×(1/Vᵢ) dollars.

8. A method of generating carpool fares used by at least one passenger in a car using a carpool scheme and comprising steps of
recording a get-in distance, a get-out distance and an accumulated distance of each passenger and a number of passengers; and
calculating an economical fare with the get-in distance, the get-out distance, the accumulated distance and the number of passengers.

9. The method of generating carpool fares as claimed in claim 8, wherein
the car travels at a car speed and has a lag speed, the car speed is variable when the car is traveling, the lag speed is a fixed value for charging an additional fare when the car is in slow traffic, and
the method for carpool fares further comprises steps of
recording a lag time when the car speed is less than the lag speed; and
calculating a lag fare with the lag time and adding the lag fare to the economical fare.
